(19) United States
(12) Patent Application Publication
(10) Pub. No.: US 2009/0186694 A1
(43) Pub. Date: Jul. 23, 2009

(54) VIRTUAL WORLD PLATFORM GAMES CONSTRUCTED FROM DIGITAL IMAGERY

(75) Inventors: Asela J. Gunawardana, Seattle, WA (US); Graham Andrew Michael Sheldon, Seattle, WA (US); Nishant Dani, Redmond, WA (US); David M. Chickering, Bellevue, WA (US); Christopher A. Meek, Kirkland, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/015,556

(22) Filed: Jan. 17, 2008

(51) Int. Cl. A63F 13/00

(52) U.S. Cl. 463/31

(57) ABSTRACT

An interactive game within a virtual world platform is provided wherein a sender can hide an object within a mapping application. An intended recipient of the object can be notified that the object is available and a clue can be provided. The clue can direct the recipient in searching for where the object is hidden. The objects can be intended for a single recipient, multiple recipients, or open to everyone on a first-come-first-served basis. The objects can be stolen by others and/or the objects can be re-gifted after being found. After being found, the virtual object can be automatically or manually converted into a non-virtual object.

### BACKGROUND

Electronic storage mechanisms have enabled accumulation of massive amounts of data. For instance, data that previously required volumes of books to record data can now be stored electronically without expense of printing paper and with a fraction of space needed for storage of paper. In one particular example, deeds and mortgages that were previously recorded in volumes of paper can now be stored electronically. Moreover, advances in sensors and other electronic mechanisms now allow massive amounts of data to be collected in real-time. For instance, GPS systems track a location of a device with a GPS receiver. Electronic storage devices connected thereto can then be employed to retain locations associated with the GPS receiver. Various other sensors are also associated with similar sensing and data retention capabilities.

Today's computers also allow utilization of data to generate various maps. For instance, Internet mapping applications allow a user to type in an address or address(es), and upon triggering a mapping application a map relating to an entered address and/or between addresses is displayed to a user together with directions associated with such map. These maps are conventionally static—for instance, if the maps are displayed on a portable mechanism (e.g., a smart phone, a PDA, and so forth), the maps do not alter with sensed changes in location of the user. Moreover, mapping applications that do alter display dynamically and/or graphically traverse a particular route do not alter depth of such view.

Due to their high quality and ease of use, a schematic destination map can be used for many important real-world purposes. Event organizers (e.g., wedding planners) provide special-purpose maps to show invitees how to get to the event location. Franchise chains and shopping districts provide schematized maps, which highlight store locations. Airports and tourist agencies often provide simplified maps to show out-of-town visitors the best/easiest ways around town. Corporations, universities, hospitals, zoos, and other campus-based organizations provide maps to show the position and relationship of important buildings and paths on respective campuses.

Social networks provide a single-location repository of text, pictures, video, audio and other information that a user publishes on their individual social network website. A person viewing a particular social network website can post information, such as a message, a picture, or other data that the individual who controls the website, as well others who visit the website, can view. Users of social networks can also interact with a mapping application to communicate locations or directions.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with an interactive virtual world platform game. The game can be constructed through digital imagery and can allow users (e.g., individuals, organizations, and so forth) to hide various items (e.g., gift, coupon, reward, rebate, prize, and so on) at different locations in a subset of the virtual world. In accordance with some aspects, the recipient of the gift can be given a clue as to a hidden location of the item. Upon remotely accessing the location where the item is hidden, the recipient obtains the item and can use that item as desired. The item can be obtained virtually or converted to a real object and used in the physical world. Remotely accessing the location can include a position (latitude/longitude) within a subset of the virtual map, a zoom level, or combinations thereof.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates a system that provides an interactive game within a virtual world platform.

FIG. 2 illustrates a system for providing an interactive virtual world game.

FIG. 3 illustrates an exemplary virtual world segment in accordance with the disclosed aspects.

FIG. 4 illustrates a method for facilitating participation in a game presented on a virtual world platform.

FIG. 5 illustrates a method for allowing virtual objects to be hidden at various locations on a virtual map.

FIG. 6 illustrates a method for hiding an object within a virtual world platform.

FIG. 7 illustrates a method for retrieving a virtual object.

FIG. 8 illustrates a method for stealing an object from an intended recipient.

FIG. 9 illustrates a block diagram of a computer operable to execute the disclosed aspects.

FIG. 10 illustrates a schematic block diagram of an exemplary computing environment operable to execute the disclosed aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

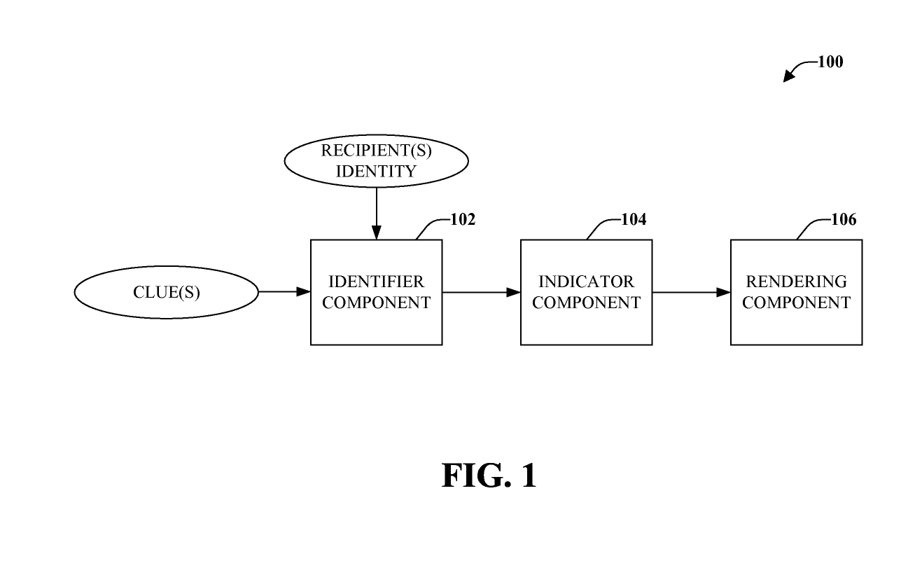

Referring initially to FIG. 1, illustrated is a system 100 that provides an interactive game within a virtual world platform. The interactive game can be played within a mapping application wherein places within a map segment are chosen to hide and/or locate a virtual object, such as a gift, certificate, or other item. System 100 can provide the interactive game to allow users to hide a gift, to participate in a treasure hunt, to test their knowledge in a trivia game, or for other forms of amusement (e.g., stealing a virtual object from others, re-giving or re-gifting an object, and so forth). The clues can be trivia clues, treasure hunt clues, or other clues. For example, a clue can state that object is hidden in “a park in Seattle sharing it's name with a 2004 presidential candidate.” This clue might lead the receiver of the object to Kerry Park. When the location (Kerry Park) is displayed, an object can be presented or a new clue to a different location can be presented.

In further detail, system 100 includes an identifier component 102 that can be configured to associate one or more recipients with clues associated with a virtual location where an object can be found. The object can be hidden within a virtual map, a cartography/satellite imaging database or another front end mapping application as a platform for games. Utilizing an existing platform mitigates the need for authoring or creating a separate platform specifically for the game, which can be both time consuming and costly.

Identifier component 102 can also associate information relating to the sender or giver of the object (e.g., GiverID), information relating to the intended recipient(s) of the object (e.g., ReceiverID), and/or information relating to the object or gift (e.g., ObjectID, GiftID). Other information that can be associated to the object by identifier component 102 can be a latitude/longitude associated with the location where the object is hidden and/or a zoom level at which the object is hidden. A number of clues might be associated with the object, and this clue string can be maintained by identifier component 102. As the recipient progresses through the clues to the ultimate location of the object, identifier component 102 can provide information such as the number of clues remaining, the amount of time left in the game, or other information.

Also included in system 100 is an indicator component 104 that can be configured to convey the clues to the recipients. A first clue can be presented in conjunction with a notification that an object (e.g., gift) is available for the recipient. In accordance with some aspects the clue (and associated object) might be visible only to a single, intended recipient, to a group of individuals (e.g., friends) selected by the sender, associated with the recipient, or combinations thereof, or visible to the world in general (e.g., all users). If the object and/or clue are visible to users, other than the intended recipient, those users may or may not be allowed to recover the objects. This determination can be made based on preferences of the sender, preferences of the receiver(s), system 100 parameters, or based on other factors.

A rendering component 106 can be configured to selectively match an entered guess with a virtual location, which can be displayed within a virtual world platform. The entered guess can be received in response to the clues. If the entered guess matches the location where the object is hidden, the object or a next clue can be presented to the recipient. Rendering component 106 can output the object so that it is displayed on the recipient's profile page. In accordance with some aspects, rendering component 106 can be configured to convert the virtual object into a real object. For example, if the virtual gift is a bouquet flowers, at substantially the same time as the gift is found, if the sender entered the appropriate information (e.g., phone number, payment information, and so forth), an automatic order to a flower shop can be placed. Rendering component 106 can also provide an electronic coupon or electronic code that can be utilized (e.g., printed out) in order to convert the virtual object into a real object.

If the entered guess does not match the location where the object is hidden, an error message can be presented to the recipient indicating that the guess was incorrect and to try again. Alternatively or additionally, the error message might indicate that the zoom level is incorrect (e.g., the area on the display should be zoomed in or zoomed out), if the zoom level is needed to retrieve the object.

In accordance with some aspects, a heat map might be associated with the map application. For example, a hot or cold layer can be displayed to indicate whether the guessed location is “hotter” or close to the actual location. Different shades of color can be displayed depending on the proximity of the guessed location to the actual location (e.g., alters in shade from light pink, for further away, and bright red, for very close). Shades can also be displayed depending on how “cold” or far away the guess is from the actual location (e.g., moves in shade from light blue for far away to dark blue for farthest away). However, other color combinations, shades, and selections can be utilized.

In accordance with some aspects, multiple independent games can be hosted in the virtual world platform at substantially the same time. The participants in each of the independent games might be able to see the clues, objects, location guess, players and/or other data related to all games. Based on system 100 parameters or other considerations (e.g., whether the object is available only for the intended recipient or whether others can redeem the gift) players of a first game might be able to participate in a second game (or more games) that are occurring at substantially the same time. In accordance with other aspects, individuals utilizing the mapping application for any function (e.g., to view a desired area, to find driving directions, and so forth) can participate in some games, even though those individuals were not originally participating in any game.

For example purposes and not limitation, as the game is played, a friend (e.g., recipient) can navigate to the “right” place (e.g., place where the object is hidden) on the virtual world platform as rendered in a special web-client. The friend can “recover” the gift, which then appears on a profile page associated with the friend. As another example, a husband can give a rose to his wife and the hint could be “the restaurant where we had our first date.” The wife can navigate to the restaurant and zoom in to a particular level to cause the rose to appear on her profile page.

System 100 can provide variations. For example, friends or other contacts can steal a gift from an intended recipient. The friend or contact can send a hint to the intended recipient on how (or where) to retrieve the object. Another variation can be re-gifting. Recovered gifts can be given to others, with clues, so that someone else can recover the gift.

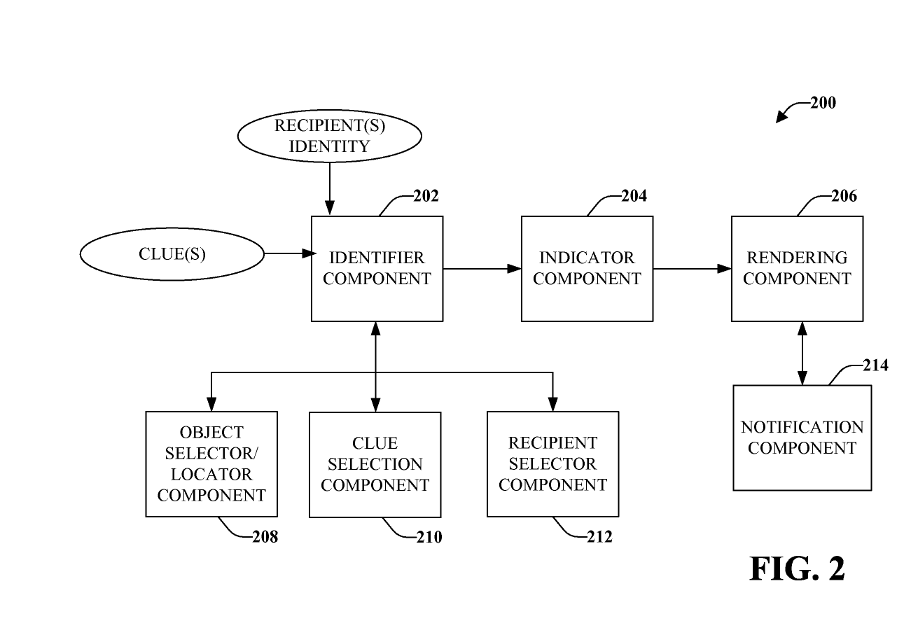

FIG. 2 illustrates a system 200 for providing an interactive virtual world game. System 200 can be an interface between a virtual world platform and a social network application. Objects and associated locations can be stored as collections. The objects can be personal in nature and can provide an expression of sentiment for friends and the added element of location can make the gift even more special and personal. In a social aspect, hidden gifts can be given to more than one person. Upon seeing the gifts, other users might want to give and receive gifts. In accordance with some aspects, a gift might be up for grabs and the first person to find the gift wins. In a virtual context, gifts can be found and hidden frequently. For example, if someone gives a gift, the recipient might reciprocate and give someone else a gift, and so on.

System 200 includes an identifier components 202 that can be configured to correspond one or more recipients with at least one clue associated with a virtual location and an indicator component 204 that can be configured to convey the at least one clue to the one or more recipients. Also included in system 200 can be a rendering component 206 that can be configured to selectively match an entered guess received in response to the at least one clue with a virtual location. Rendering component 206 can display the location within a virtual world platform and, if the correct location is found, output the virtual object and/or instructions on how to convert the virtual object into a real object.

Also included in system 200 can be an object selector/locator component 208 that can be configured to receive a selection of a virtual object to hide. The virtual object can be a gift, a message, a coupon, a reward, a rebate, a prize and so forth. The object can be selected from a list (e.g., drop down list), from presented icons, or manually entered. The object selector/locator component 208 can also be configured to accept a virtual location where the object should be hidden (e.g., the location entered by the sender).

A clue selection component 210 can be configured to accept and associate a clue (e.g., related to the virtual location where the object is hidden) with the object and the location where the object is hidden. The clue selection component 210 can further retain a clue string or other association between two or more clues that are provided to retrieve an object. For example, a first clue can lead to a location and, once that location is “found” a second clue is provided leading to another location, and so forth, until the final location is “found”.

In accordance with some aspects, instead of a clue leading to a gift as described above, navigating to the right location at the right zoom level solves the clue. Solving the clue can earn trivia points (in a trivia version) and/or reveal the next clue. For example, a first clue is “a spinning restaurant in Seattle.” Navigating to the Space Needle and zooming in to a particular viewing level earns points and reveals the next clue: “A park that shares a name with a presidential candidate.” Navigating to Kerry Park and zooming reveals the next clue, and so forth.

Variations can include treasure hunts tailored to specific cities, neighborhoods or schools. Another variation can allow users to create their own treasure hunts/trivia games.

Also included in system 200 can be a recipient selector component 212 that can be configured to receive an identification of an intended recipient or recipients. The intended recipient can be a single individual, multiple individuals, contacts associated with the single individual or multiple individuals, as well as others. In accordance with some aspects, the intended recipient is anyone willing to search for and discover the object (e.g., on a first come, first served basis).

The users can interact with the various system components though a user interface component (not shown). For example, the user interface component can provide a graphical user interface (GUI), a command line interface, a speech interface, Natural Language text interface, and the like. For example, a GUI can be rendered that provides a user with a region or means to choose an object, provide clues, enter a location guess and can include a region to present the results of such guesses. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

A notification component 214 can be included in system 200 to notify the recipient(s) that an object is available. The recipient(s) can accept the notification and receive a clue to retrieve the object. In some situations, the recipient(s) might not want to participate and can turn down or deny the request. If the request is denied, the sender of the object might receive a notification that the game was denied and that the object is available for others.

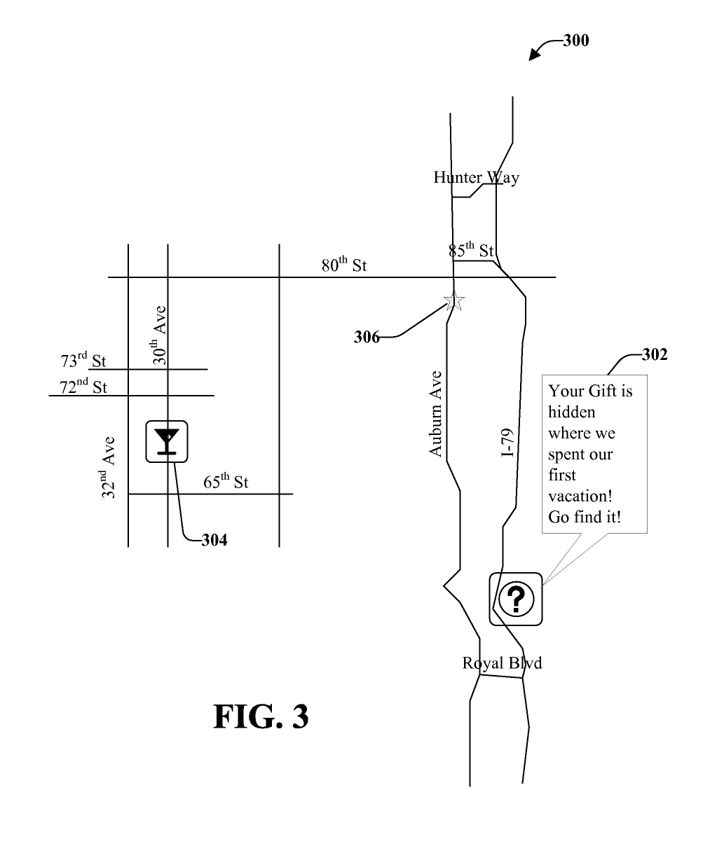

FIG. 3 illustrates an exemplary virtual world segment 300 in accordance with the disclosed aspects. The disclosed aspects allow individuals to give free gifts to friends and hide the gifts in various locations around the world, virtually. The sender can give the intended recipient a hint and make the recipient hunt for the gift in a virtual world platform. The recipient(s) might only receive the gift when it is successfully found in the location (and appropriate viewing level) where the sender left the gift in the map. Senders can send flower's to their mom's work, leave a special gift on a neighbors doorstep, or place a virtual drink on a virtual Empire State Building. The choices are endless.

The disclosed interactive game can be associated with a particular segment or portion of a virtual world, such as a few blocks in a city, an entire city, or other viewing levels. The recipient, in order to retrieve the gift, might need to be at substantially the same (e.g., plus or minus ten percent, plus or minus five percent, and so on) viewing level as the viewing level used by the sender to hide the gift.

A clue is illustrated, at 302, and can be presented when the recipient guesses that an object is hidden at a particular location but a clue is hidden at the location rather than the object. The clue can include a trivia clue, a treasure hunt clue, a personal clue, or combinations thereof. Although the clue is illustrated as a call-out associated with an icon of a question mark, other formats can be utilized to present the clue.

Icons associated with gifts are illustrated, at 304 and 306. It should be noted that although the map segment 300 is illustrated at a street viewing level, other viewing levels can be utilized. For example, the recipient might zoom in so that a single house or a single building is illustrated and the recipient can select a window or door (e.g., from a side viewing angle or other trajectory) in order to claim the gift. Additionally, a multitude of objects can be hidden including virtual gifts, words, phrases, and other gifts or items that might be of interest to the recipient.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the disclosed aspects are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component, and so forth). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

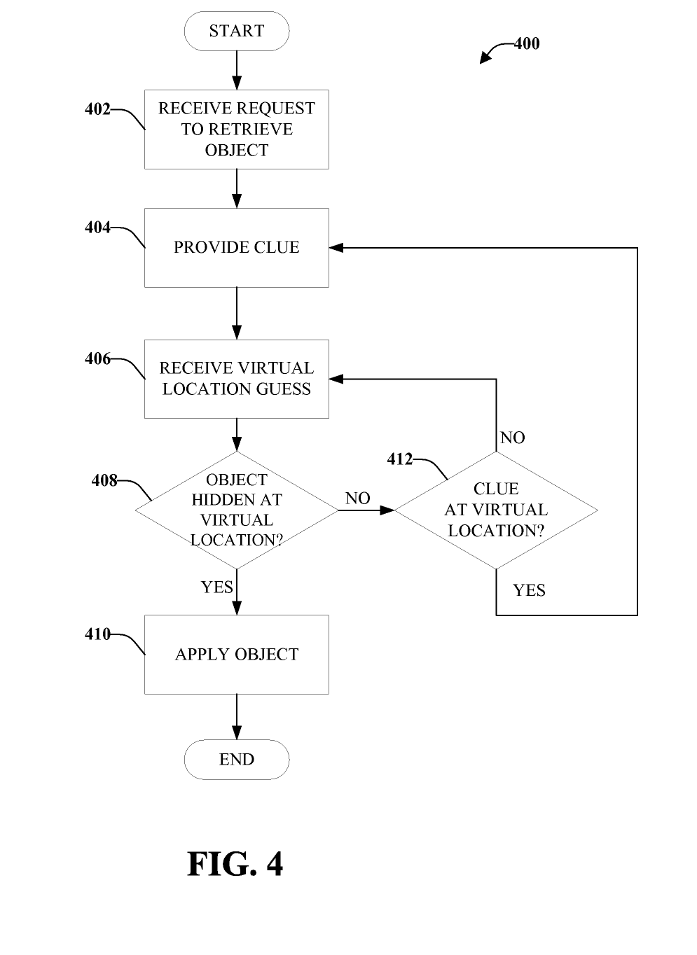

FIG. 4 illustrates a method 400 for facilitating participation in a game presented on a virtual world platform. Method 400 facilitates providing entertainment for users in a virtual world platform. The entertainment can be constructed from digital imagery. The game provided by method 400 can educate users relating to the various features associated with a mapping application, a social network application, or both applications.

Method 400 starts, at 402, when a request to retrieve an object is received. The request can be in response to a user receiving a notification that an object, such as a virtual gift, is available for the user. This user is referred to as a recipient or intended recipient. The virtual object can be provided by a person that knows the user (e.g., spouse, friend, colleague, and so forth), referred to as a sender.

In accordance with some aspects, the request to retrieve the object can be from an individual associated with the intended recipient, such as a contact or buddy included in a buddy-list or contact-list maintained on the recipient's device. The individual can intend to steal the object and re-hide the object (with an associated clue) before the intended recipient can retrieve the object. For example, a virtual object is intended for User A and there are rights associated with the virtual object that allows other users (e.g., User B, User C, and so forth) to selectively retrieve the object. The other users (User B and User C) can retrieve the object before User A claims the object and provide a clue as to the new location of the object or retain the object for their our purposes.

According to some aspects, the virtual object could also be provided by an advertiser (such as a product manufacturer or distributor) to selected individuals that are associated with a product, registered on a mailing list, applied for a sweepstakes, or though other interactions. The virtual object provided by the advertiser could be a coupon for a free gift, a code for a discount for goods or services, an entry into a sweepstakes, or other incentives that can be used in the non-virtual or real world.

At 404, a clue is provided that assists the recipient in discovering the location of the virtual object on a virtual mapping application. The clue can be provided by the sender or an individual that previously stole the object (e.g., impostors). For example, a clue can be provided by the sender such as, “Where our business was launched.” The clue should be one that can be understood and solved by the recipient, although, at times solving the clue might take some time and a number of incorrect guesses.

In response to the provided clue, a virtual location guess is received, at 406. The virtual location guess can be based on a location selected in a virtual mapping location (e.g., pointing at an area on a map segment with a pointer) and indicating that the particular location is a guess (e.g., selecting on option on a screen or typing in a particular word or phrase “here is my guess”, and so on). The location guess can also be based on a viewing level of the map segment. The viewing or zoom level might be to enlarge a particular portion on the map segment in order to see more detail relating to a map segment. For example, the map segment might be zoomed into until details of a house or building (e.g., a door, window, and so forth) are clearly visible to the recipient.

Based on the received location guess, a determination is made, at 408, whether the object is hidden at the guessed location. If the object is hidden at that location (“YES”), the object is applied to the user. The object can be applied by associating the object with the user, such as displaying the object (or icon of the object) on the user's home page, profile page, or though other means. The user is now the virtual owner of the object and can retain the object, re-gift it to someone else, or use the object for some other function (e.g., barter, buy virtual items, and so forth).

In accordance with some aspects, the recipient can convert the virtual object to a real (e.g., non-virtual) object. For example, a clue is given that states, “find flowers where we had our first date”. The recipient finds the flowers in the virtual map at a restaurant (or other place where the flowers are hidden). At substantially the same time as the flowers are found, an automatic order is placed (e.g., email, call, and other manners of placing an order) to a flower shop. The sender, while hiding the object would enter the appropriate ordering information (e.g., payment information, item information, recipient information) in order to allow the non-virtual objects to be converted to real world objects. In accordance with some aspects, the recipient is given a coupon or code, which can be used (e.g., entered into a specified website, printed out and presented in a store, and so forth) to place an order and retrieve the real world object.

If the determination, at 408, is that the object is not hidden at the virtual location (“NO”), method continues, at 412, and a determination is made whether there is a clue at the virtual location, such as in a treasure hunt scheme. If there is no clue (“NO”), it indicates that the recipient has guessed an incorrect location from which to retrieve the virtual object and/or the viewing level is not correct (e.g., view should be zoomed out or zoomed in). If there is no clue at the virtual location, method 400 can end until a subsequent virtual location guess is received at 406. If there is another clue at the virtual location (determination, at 412, is “YES”), method 400 continues, at 404, and the subsequent clue is provided. The subsequent clue can direct the user to a next virtual location (e.g., such as a treasure hunt scheme). It should be understood that this act can be continuous until all clues are presented to the user and/or until the object is discovered.

It should be noted that method 400 does not have to occur during a single user session. Thus, if the user does not find the virtual object during a single session, the status of the current game can be retained and resumed later, as desired.

In accordance with some aspects, various parameters are associated with the virtual games. A time limit can be a parameter, wherein the recipient has a predefined interval during which the object must be found. In the interval expires, the object might be no longer available, might be reduced in value, or some other penalty might apply (e.g., a code is provided for a 50% discount if found within two hours, however, if it is found after 2 hours, the discount is reduced to 20%). The interval can begin when the first clue is presented to the recipient. The game can be paused or interrupted and the time associated with each game segment can be combined to determine an overall time.

Another parameter can be a limited number of attempts to retrieve the object. The attempts can be determined by the user selecting a location on a map segment and a particular viewing level (e.g., zoom level) and accepting that location/level. If the map segment or the viewing level are not correct, the user can retry up to a predetermined number of attempts. Once the allowed number of attempts are met or exceeded, the object might no longer be available, might be reduced in value, or some other penalty might be applied.

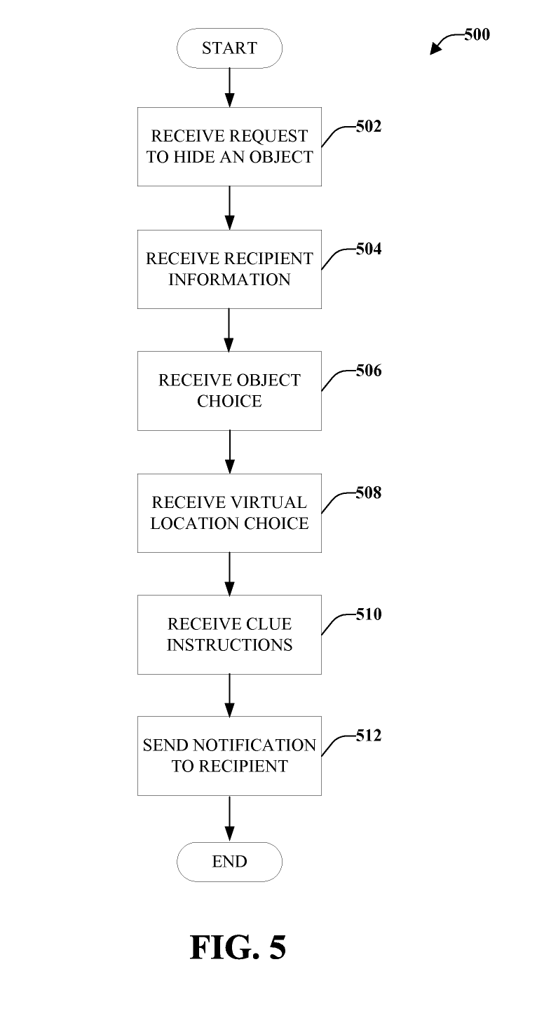

FIG. 5 illustrates a method 500 for allowing virtual objects to be hidden at various locations on a virtual map. Method 500 starts, at 502, when a request to hide an object for at least one recipient is received. In accordance with some aspects, the object can be hidden for multiple recipients on a first-come-first-serve basis. In some aspects, multiple objects can be hidden for one or more recipient at a single location or at different locations. For example, a first gift can be hidden at a first location, a second gift hidden at a second location, and so forth. The first user to discover one or more of the locations can receive and retain (or convert) the gift. A subsequent user might virtually arrive at the location, however, since the gift has already been redeemed, the subsequent user might receive a second gift or might be given a clue to virtually traverse to a next location to retrieve another gift.

At 504, information associated with the recipient of the gift is received, which can be in response to a prompt for the information. The recipient information can include enough details to distinguish the recipient from others. Such information can include an email alias, a screen name, a user identification/password pair, an Internet Protocol address, a telephone number, and other forms of identification.

The object choice can be received, at 506. The choice can be made by a user selecting among different gift choices or creating a gift choice. The selection can be made by choosing icons or names of gifts (e.g., from a list) that are predefined or available for use. In accordance with some aspects, the user can submit or supply a gift to be given if the desired gift is not available. For example, if the user desires to virtually give someone a new car and the desired type of car that the user wants to give, or knows that the recipient would like to receive, is not provided, the user can submit a picture or icon of the particular car for hiding at the desired location.

At 508, one or more location choices are received. The choices can be selected based on a selection provided directly within the mapping application by a user moving a mouse or pointer over a location and clicking or selecting the particular location. Alternatively or additionally, the location choice can be received based on an entered address, geographic coordinates, or based on other information (e.g., location description, location type). In accordance with some aspects, the viewing or zoom level at the time of placing the virtual object can be a parameter associated with retrieving the object (e.g., recipient has to be at a similar viewing level).

Since the selected object and the selected location might be personal to the sender of the gift and the recipient, one or more clues can be received, at 510. If more than one clue and/or location is received, each clue can be associated with a particular location. The clue can be a text message (e.g., “the place where we had our first date”), an image (e.g., picture of building, landmark, or other place), or provided in other formats (e.g., a sound, a verbal word or phrase, and so forth).

At 512, a notification is sent to the intended recipient to indicate that a gift is available. The notification can be an email message, a text message, a phone call, or sent though other perceivable means. In accordance with some aspects, the sender can manually initiate the notification. The notification can include a simple message indicating that a gift is available and whether or not the recipient would like to retrieve the gift, allowing the user to opt-out of the game. Alternatively or additionally, the notification can include the first clue.

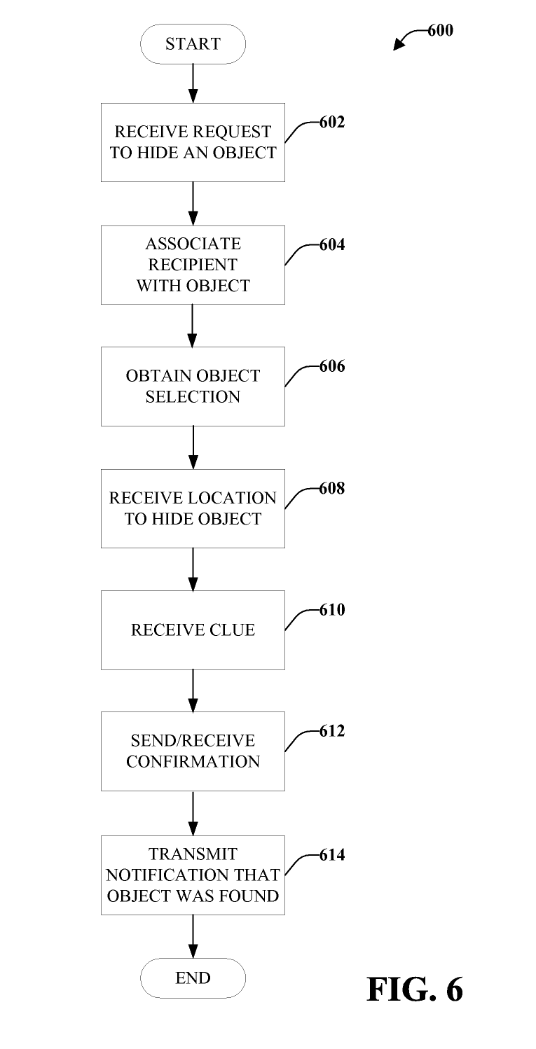

FIG. 6 illustrates a method 600 for hiding an object within a virtual world platform. Objects, such as gifts, are widely used in social applications to make friends, associates, and others feel special, to wish someone a nice day, or simply to interact with others and express feelings. Although the aspects herein are described with reference to “gifts”, any type of object can be utilized with the disclosed aspects, such as coupons, gift certificates, prizes, discounts, and so forth.

Method 600 starts, at 602 when a request to “Hide an Object” is received from a user. The request can be received when the sender clicks or selects a prompt or selection to hide a gift. The user can then choose a recipient or more than one recipient to whom the sender wants to send a virtual gift. The recipient(s) can be input based on various identifiers, including but not limited to, an email alias, an Internet Protocol address, and a screen name. At 604, the recipient(s) are associated with the gift. This association can provide a linkage between the recipient, the particular object, and the sender of the object. The association can provide that others, not intended to be the recipient of the particular object, are not able to retrieve and/or retain the particular object. However, in accordance with some aspects, the association allows contacts of the recipient to also receive the notification and clue as well as the possibility to retrieve the gift.

The sender can select an object to send and the selection is obtained, at 606. The object can be selected from a menu, a list, icons, and so forth. In accordance with some aspects, the object can be input by sender. For example, sender can obtain an image of the desired object and present that image for acceptance as the virtual object. In accordance with some aspects, the object can be text (e.g., “Wishing you a nice day.”), a document, spreadsheet, an application, and others.

A location within a map segment where the object should be positioned or hidden is obtained, at 608. The location can be selected when the sender clicks on a place within a map segment (e.g., through a mouse or other selection means), by entering an address (e.g., 9801 Franklin Boulevard, Broadcaster, Nev.), by entering geographic coordinates (e.g., latitude and longitude, or other coordinates), or though other means of identifying a location with a virtual map. The location can be identified by a marker (e.g., arrow pointing to the location, star over the location, and the like) or a pushpin that is saved at the location. The marker or pushpin can be visible to the sender, however, it should not be visible to the recipient if the gift is hidden and, to find the gift, the recipient needs to search for the gift. If the marker or pushpin is located in an incorrect place, or if the sender desires to change the location, the marker or pushpin can be selected and moved and/or another location can be entered.

At 610, a clue associated with the object/location is received. The sender can provide clues in a multitude of formats, such as text (e.g., “Where we met”), pictures (e.g., a house that the sender/receiver is interested in purchasing), or though other perceivable manners (e.g., audio).

At substantially the same time as the recipient, object, location, and clue are received, which can be in any order, a confirmation request is sent, at 612. This confirmation request can include the entered information (e.g., object, location, clue, recipient) and request a confirmation that the information is correct. If the information is not correct, the sender can be provided the opportunity to correct the information. If the information is correct, the sender accepts the information, and the acceptance is received, at 612.

After confirmation is received, a notification can be sent to the recipient indicating that an object is available. The notification can be sent at substantially the same time as the confirmation is received or at a time designated by the sender, which can be a selection available when the relevant information is entered. In accordance with some aspects, the notification is sent to individuals associated with the recipient.

Method 600 can continue, at 614, when a notification is transmitted to the sender indicating that the receiver has found and accepted the object. This notification can be sent any time after the sender has confirmed the object information. It may take the recipient time to find the object or to become aware that an object is available. For example, the recipient might not check their incoming messages for days, weeks or months. Additionally, the recipient might not have the time to find the object when the notification is received or it might take some time to find the object (e.g., multiple sessions) depending on the complexity of the clues. Thus, the clue and other information associated with the hidden object can be provided to the sender along with the information that the gift was accepted, thus, allowing the sender to identify the particular gift/recipient.

In accordance with some aspects, multiple clues, locations, and/or gifts can be selected for a single recipient. For example, a treasure hunt type of atmosphere can be created whereby one or more recipients virtually travel to different locations based on clues left for the recipient at each location. The recipient(s) can receive a first clue, upon successfully arriving, virtually, at the location, a second clue is presented, leading the recipient to a next location. This can continue any number of times as established by the sender. At the end of the treasure hunt, the recipient can retrieve and/or convert the gift.

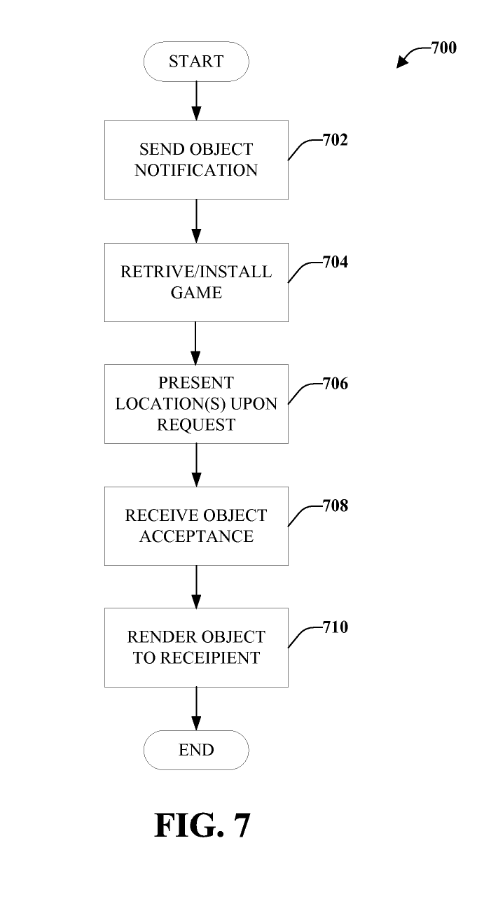

FIG. 7 illustrates a method 700 for retrieving a virtual object. Method 700 starts, at 702, when an object notification is sent to a recipient. The notification can be sent in any format (e.g., text message, email message, voice message, and so forth) and within a variety of platforms or applications, which can be associated with social networks. The information included in the notification can be selected by the sender or the information can be automatically generated, based on an identification of the sender, identification of the receiver, based on the clue or based on other information utilized to generate the notification. For example, the notification can be in any perceivable format (e.g., audible, visual) and can state such information such as, “Graham has sent you a gift and hide it where you had your first date. Go find it!”

At 704, an application associated with the treasure hunt game can be installed, if the game has not been previously installed on the user device. If the game has been installed, the application can be retrieved from the user device. In accordance with some aspects, at 704, a previous game, that was not completed or solved, can be retrieved.

As the recipient navigates to the location where the gift might be hidden, the location is presented or displayed on the user device, at 706. Navigating to the location can include entering an address (e.g., 61064 Englewood Drive, Bentonville Heights, N.Mex.), entering an intersection (e.g., Chester Avenue and Westin Drive, Richton, Ak.), entering landmark information (e.g., Empire State Building), browsing various locations (e.g., requesting a city to be displayed and visually searching for a location), and well as other means of navigating within a virtual mapping application.

Navigating to the location can also include a particular zoom level. For example, the object might not be available until the recipient zooms in (or out) to a particular viewing level in an area of a map segment. By providing that the recipient has to navigate to a portion of a map segment at a specific zoom level can mitigate the object being rendered when the user navigates to a city or state, which would not be challenging nor might not produce the result intended by the sender.

At substantially the same time as the recipient navigates to the proper location and/or level of detail associated with the object, the recipient can select whether to accept the gift and the acceptance can be received, at 708. For example, a prompt can be presented to the recipient asking if the recipient would like to retain the object. The prompt can be a text message on a display screen wherein the recipient selects “Yes” to retain the gift or “No” to not retain the gift. In accordance with some aspects, the prompt, response, or both the prompt and the response can be processed through verbal commands. In accordance with some aspects, the object is automatically retained by the recipient and no prompt is provided (e.g., at substantially the same time as the gift is found it is applied to a profile page associated with the recipient). According to some aspects, the recipient might desire to hide the object for a subsequent recipient to find.

If an acceptance of the object is received, the object can be rendered to the recipient, at 710. Rendering of the object can include displaying an object as an icon, picture, graphic, and so forth on a display or through other means (e.g., audible sound indicating “You have a flower sent by Bill!”, for example). The visual representation of the object can be retained in a place associated with the recipient, such as a page in a social network, a “Treasure Chest” on a profile page, or various other virtual places. In accordance with some aspects, the virtual object can be automatically converted to a real object (e.g., order placed to send the real object to the recipient) or information can be provided (e.g., coupon, code) to allow the user to manually retrieve the real world object.

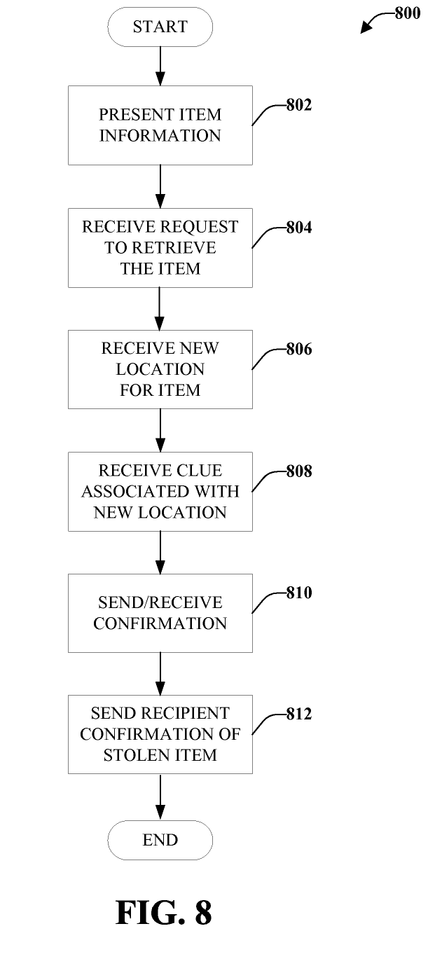

FIG. 8 illustrates a method 800 for stealing an object from an intended recipient. Stealing an object can be a variation of finding an object. At 802, information associated with a hidden item is presented to the intended recipient. The information can include a clue relating to the location of the hidden item, a sender of the item, or other information intended to arouse the recipient's interest in searching for the item. The information relating to the hidden object can be obtained by others associated with the recipient, referred to herein as impostor. For example, the sender can indicate when hiding the item that contacts of the intended recipient can access the item. The contacts (potential impostors) can be identified by a contact list, email list, or other listing of individuals maintained on the recipient's device. In accordance with some aspects, the sender can identify additional users (potential impostors) that can access the item and, therefore, steal the item, if desired.

At 804, a request to retrieve the item is received from the impostor. This request is received before the intended recipient has found and retained the item. The impostor can request to retrieve the item by viewing the items available for the intended recipient to find and then specifically requesting to find one or more of those items. The specific request can include selecting a “Plunder!” button on a display or though other techniques of interacting with the gaming application.

The impostor then attempts to retrieve the item in a manner similar to that described above. Upon successfully retrieving the item before it is retrieved by the intended recipient, the impostor can re-hide the item and, at 806, a new location to place or hide the item is received. The item is moved to the new location in the virtual word. The new location might also be associated with a viewing level or zoom level. A clue associated with the new location as specified by the impostor is received, at 808.

A confirmation request is sent to the imposter, at 810. The confirmation request can attempt to verify the new location of the item and the clue associated with the new location. The verification can mitigate items being lost due to the item being located where it will not be found or a clue that has an unclear meaning, resulting in the item not being found.

At 812, a notice can be sent to the intended recipient indicating that the item was “stolen”. For example, the intended recipient might receive a notice that indicates, “Theresa stole your gift and hid it in your office. Get it back!”. Potential impostors might also receive this notification. Thus, the intended recipient (and potential impostors) can retrieve the item based on the new clue.

In accordance with some aspects, the new clue is hidden at the previous location, which is the location (and zoom level) where the impostor found the item. Thus, as the intended recipient (or other potential impostors) attempts to retrieve the item, rather than finding the item at the location, a clue is provided leading the intended recipient (or other potential impostors) to a new location. In this aspect, the intended recipient might not receive a notification that the item was stolen.

Thus, method 800 can provide an interactive game that allows multiple individuals to participate, even if such individuals are not the intended recipient. Alternatively or additionally, method 800 can provide a competitive game wherein individuals attempt to retrieve items and re-hide the item before others are able to find the items.

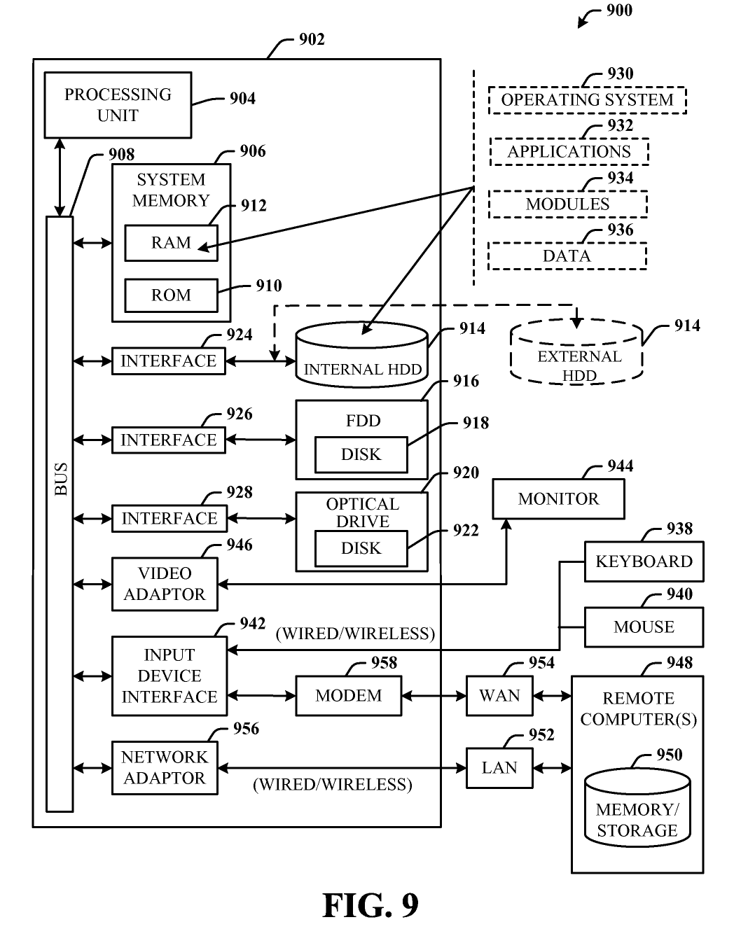

Referring now to FIG. 9, there is illustrated a block diagram of a computer operable to execute the disclosed architecture. In order to provide additional context for various aspects disclosed herein, FIG. 9 and the following discussion are intended to provide a brief, general description of a suitable computing environment 900 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the various aspects can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

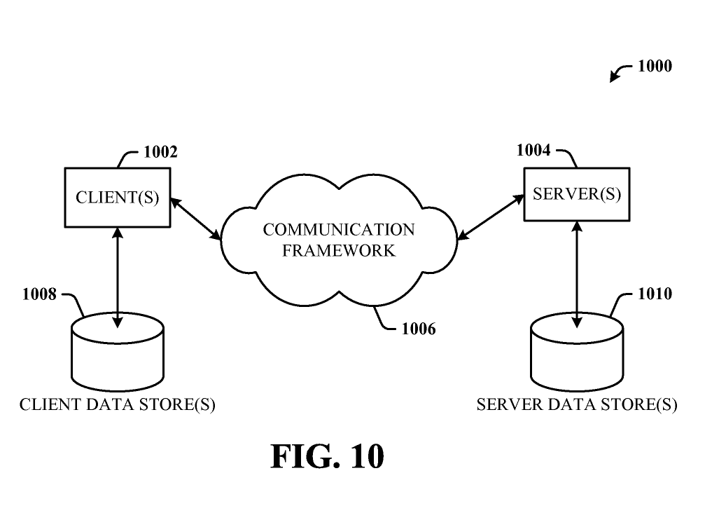

Referring now to FIG. 10, there is illustrated a schematic block diagram of an exemplary computing environment 1000 in accordance with the various aspects. The system 1000 includes one or more client(s) 1002. The client(s) 1002 can be hardware and/or software (e.g., threads, processes, computing devices). The client(s) 1002 can house cookie(s) and/or associated contextual information by employing the various aspects, for example.

The system 1000 also includes one or more server(s) 1004. The server(s) 1004 can also be hardware and/or software (e.g., threads, processes, computing devices). The servers 1004 can house threads to perform transformations by employing the various aspects, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated through a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” The term “or” as used in either the detailed description of the claims is meant to be a “non-exclusive or”.

The word “exemplary” as used herein to mean serving as an example, instance, or illustration. Any aspect or design described herein as “exemplary” is not necessarily to be construed as preferred or advantageous over other aspects or designs.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that facilitates an interactive game within a virtual world platform, comprising:
an identifier components that corresponds one or more recipients with at least one clue associated with a virtual location;
an indicator component that conveys the at least one clue to the one or more recipients; and
a rendering component that selectively matches an entered guess location received in response to the at least one clue with a virtual location and displays the location within a virtual world platform.

2. The system of claim 1, the rendering component matches a zoom level of the entered guess location with a zoom level of the virtual location.

3. The system of claim 1, further comprising:
an object location/selector component that receives a selected object and hides that object at the virtual location;
a clue selection component that associates a clue related to the virtual location; and
a recipient selector component that corresponds the one or more recipients with the object.

4. The system of claim 3, the recipient selector component allows contacts associated with each of the one or more recipients to retrieve the object.

5. The system of claim 1, the clue is a trivia clue, a treasure hunt clue, a personal clue, or combinations thereof.

6. The system of claim 1 is provided through interaction with a social network application.

7. The system of claim. 1, further comprising a notification component that notifies the one or more recipients of the at least one clue associated with the virtual location.

8. The system of claim 1, the rendering component automatically converts a virtual object, hidden at the virtual location, to a non-virtual object.

9. A method for facilitating participation in a game presented on a virtual world platform, comprising:
presenting a first clue to at least one user, the first clue relates to a virtual location of a hidden object;
receiving a virtual location guess based on the presented first clue; and
selectively rendering the hidden object in response to the virtual location guess.

10. The method of claim 9, selectively rendering the object in response to the virtual location guess comprises applying the object to a profile page if the virtual location guess matches the virtual location of the hidden object.

11. The method of claim 9, further comprises presenting at least a second clue to the at least one user if a clue is hidden at the virtual location guess.

12. The method of claim 9, selectively rendering the object in response to the virtual location guess comprises automatically converting the hidden object to a non-virtual object.

13. The method of claim 9, further comprising:
accepting a request to hide an object at the virtual location; and
receiving at least one clue associated with the virtual location.

14. The method of claim 9, further comprising:
receiving a request from an impostor to steal the hidden object;
approving the request; and
selectively allowing the impostor to retrieve the hidden object.

15. The method of claim 14, further comprising:
accepting from the impostor a new location to hide the object and a new clue; and
notifying the intended recipient of the impostor and the new clue.

16. The method of claim 9, further comprising:
retaining a clue string; and
notifying the at least one user of the number of clues remaining.

17. The method of claim 9, further comprising:
sending the first clue to multiple contacts listed in a contact list on a device of the at least one user; and
allowing the multiple contacts to retrieve the object before the at least one user retrieves the object.

18. The method of claim 9, further comprising:
receiving a request to re-gift the object to at least a second user; and
notifying the at least a second user of the object that has been re-gifted.

19. A computer executable system, comprising:
means for associating a virtual object with an intended recipient, a clue, and a virtual location;
means for notifying the recipient that a virtual object is available;
means for receiving a virtual location guess;
means for determining if the virtual location guess matches the virtual location; and
means for displaying the virtual object, a second clue, or an error message based on the determination.

20. The system of claim 19, further comprising:
means for linking a second recipient with the intended recipient; and
means for allowing the second recipient to retrieve the virtual object before the intended recipient retrieves the virtual object.
